(19) United States
(12) Patent Application Publication
(10) Pub. No.: US 2009/0276556 A1
(43) Pub. Date: Nov. 5, 2009

(54) MEMORY CONTROLLER AND METHOD FOR WRITING A DATA PACKET TO OR READING A DATA PACKET FROM A MEMORY

(75) Inventor: Hsiang-I HUANG, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/503,228

(22) Filed: Jul. 15, 2009

Related U.S. Application Data
(63) Continuation-in-part of application No. 11/538,543, filed on Oct. 4, 2006.

(51) Int. Cl. G06F 12/00; G06F 13/14; G06F 1/32

(52) U.S. Cl. 710/305; 711/154; 713/320; 711/E12.001

(57) ABSTRACT

A memory controller and a method for data access are provided. The memory controller writes a data packet to or reads a data packet from a memory. The memory controller comprises a first register, a second register, a data packet adjuster, and a burst length determination unit. The first register stores a data bus width. The second register stores an operating frequency of the memory controller. The burst length determination unit determines a burst length according to the operating frequency. The data packet adjuster adjusts the data packet according to the data bus width and the burst length.

This application is a continuation-in-part of patent application Ser. No. 11/538,543 filed on Oct. 4, 2006, which is incorporated by reference in its entirety.

### CROSS-REFERENCES TO RELATED APPLICATIONS

Not applicable.

### BACKGROUND OF THE INVENTION

1. Field of the Invention

The present invention relates to a memory controller and a method for writing a data packet to or reading a data packet from a memory. More particularly, the present invention relates to a memory controller and a method for writing a data packet to or reading a data packet from a memory under different bandwidths of an external memory bus.

2. Descriptions of the Related Art

Most systems require memories for storing data. A memory controller in such a system writes data packets to or reads data packets from a memory in response to a processor's instruction. In order to transmit data packets, there are data transmission channels, such as buses, between the processor, memory, and memory controller. In addition to the memory controller, the system requires several memory agents for temporary data storage before data packets are sent out. The memory agents are developed to monitor system resources. Once the system resources are available, the memory agents pass the data packets to the destination.

Because different systems have different bandwidth requirements, a memory controller should be able to support these bandwidth requirements. For example, a memory controller should be able to support different bus bandwidths.

FIG. 1 shows a block diagram of a conventional memory system 1. The memory system 1 comprises a DDR-II memory 101, a memory controller 103, and three memory agents 105, wherein DDR refers to “double data rate.” The DDR-II memory 101 operates at X MHz, i.e., 2× data rate, and communicates with the memory controller 103 via an external memory bus 107 at acceptable bandwidths of N bits and 0.5N bit. The memory controller 103 operates at X MHz as well, and communicates with the memory agents 105 via internal memory buses 109 at bandwidths of 2N bits and N bits corresponding to the bandwidths of the memory bus 107.

The DDR-II memory 101 can transfer two words in one cycle at the rising and falling edges of clocks. If the bandwidth of the memory buses 107 is set to N bits, the bandwidth of the memory bus 109 needs to be twice that of the memory buses 107, i.e., 2N bits, in order to maintain correct data transmission. Similarly, if the bandwidth of the memory bus 107 is 0.5N bit, the bandwidth of the memory bus 109 has to be N bits. This causes each of the memory agents 105 to inconveniently deal with two bandwidths, 2N bits and N bits. Thus, the complexity of the memory agents 105 is increased. As a result, the cost becomes incredibly high when the conventional memory system 1 requires many memory agents 105.

In another conventional memory system, the bandwidth of the memory buses 109 is always 2N bits. When the memory bus 107 operates at a bandwidth of 0.5N bit, the memory controller 103 has to harmonize the incompatibility due to the bandwidth differences between the memory bus 107 and the memory buses 109. The complexity of the harmonization depends on the protocol of the memory buses 109. For example, the complexity of the harmonization would be much higher if the memory buses 109 support a burst length than if the memory buses 109 only support a single word. As a result, the costs of this conventional memory system remain high. In addition, the power consumption is also considerable since the usage rate of the memory buses 109 is only 50% when the memory bus 107 operates with a bandwidth of 0.5N bit.

Accordingly, a solution that deals with an external memory bus, connected to a memory, with different bandwidths is urgently required in this field.

### SUMMARY OF THE INVENTION

An objective of this invention is to provide a memory controller for writing a data packet to or reading a data packet from a memory. The memory controller comprises a register, a data packet adjuster, and a burst length determination unit. The register sets a data bus width. The data packet adjuster adjusts the data packet according to the data bus width. The burst length determination unit determines a burst length according to the data bus width. The memory controller writes or reads the adjusted data packet in response to the burst length.

Another objective of this invention is to provide a memory controller for writing a data packet to or reading a data packet from a memory. The memory controller comprises a register, a data packet adjuster, and a frequency determination unit. The register sets a data bus width. The data packet adjuster adjusts the data packet according to the data bus width. The frequency determination unit determines an operating frequency of the memory controller according to the data bus width. The memory controller writes or reads the adjusted data packet in response to the operating frequency.

Another objective of this invention is to provide a method for writing a data packet to or reading a data packet from a memory. The method comprises the following steps: setting a data bus width; adjusting the data packet according to the data bus width; and determining a burst length according to the data bus width. The adjusted data packet is written or read in response to the burst length.

Another objective of this invention is to provide a method for writing a data packet to or reading a data packet from a memory. The method comprises the following steps: setting a data bus width; adjusting the data packet according to the data bus width; and determining an operating frequency according to the data bus width. The adjusted data packet is written or read in response to the operating frequency.

Another objective of this invention is to provide a digital television system. The digital television system comprises a memory and a memory controller. The memory controller writes a data packet to or reads a data packet from the memory, and comprises a register, a data packet adjuster, and a burst length determination unit. The register sets a data bus width. The data packet adjuster adjusts the data packet according to the data bus width. The burst length determination unit determines a burst length according to the data bus width. The memory controller writes or reads the adjusted data packet in response to the burst length.

Another objective of this invention is to provide a digital television system. The digital television system comprises a memory and a memory controller. The memory controller writes a data packet to or reads a data packet from the memory, and comprises a register, a data packet adjuster, and a frequency determination unit. The register sets a data bus width. The data packet adjuster adjusts the data packet according to the data bus width. The frequency determination unit determines an operating frequency of the memory controller according to the data bus width. The memory controller writes or reads the adjusted data packet in response to the operating frequency.

Another objective of this invention is to provide a memory controller for writing a data packet to or reading a data packet from a memory. The memory controller comprises: means for setting a data bus width; means for adjusting the data packet according to the data bus width; and means for determining a burst length according to the data bus width. The memory controller writes or reads the adjusted data packet in response to the burst length.

Another objective of this invention is to provide a memory controller for writing a data packet to or reading a data packet from a memory. The memory controller comprises: means for setting a data bus width; means for adjusting the data packet according to the data bus width; and means for determining an operating frequency of the memory controller according to the data bus width. The memory controller writes or reads the adjusted data packet in response to the operating frequency.

Another objective of this invention is to provide a memory controller for writing a data packet to or reading a data packet from a memory. The memory controller comprises a first register, a second register, a burst length determination and a data packet adjuster. The first register stores a data bus width. The second register store an operating frequency of the memory controller. The burst length determination unit determines a burst length according to the operating frequency. The data packet adjuster adjusts the data packet according to the data bus width and the burst length. The memory controller writes or reads the adjusted data packet in response to the burst length.

Yet a further objective of this invention is to provide a method for writing a data packet to or reading a data packet from a memory. The method comprises the following steps: setting a data bus width; determining an operating frequency of a memory controller; determining a burst length according to the operating frequency; and adjusting the data packet according to the data bus width and the burst length. Therefore, the adjusted data packet is written or read in response to the burst length.

The present invention provides a solution that deals with memory buses with different bandwidths. The production cost of the solution is lower than that of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional memory system;

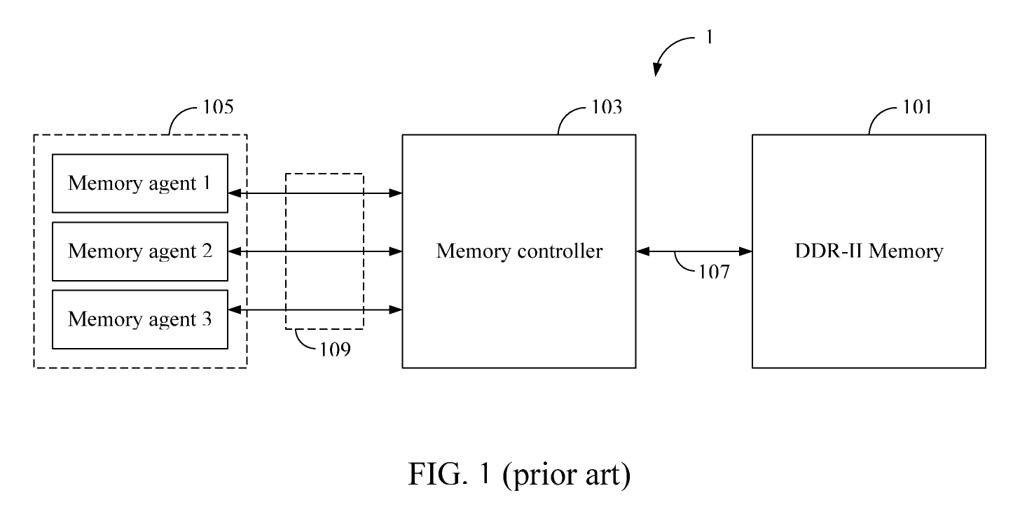

FIG. 2 illustrates a first embodiment in accordance with the present invention;

FIG. 3 illustrates a timing diagram of the first embodiment when a write operation is executed and BL=4;

FIG. 4 illustrates a timing diagram of the first embodiment when a write operation is executed and BL=8;

FIG. 5 is a flow chart of a second embodiment in accordance with the present invention;

FIG. 6 illustrates a third embodiment in accordance with the present invention; and

FIG. 7 is a flow chart of a fourth embodiment in accordance with the present invention.

### DESCRIPTION OF THE PREFERRED EMBODIMENT

In this specification, the term “in response to” is defined as “replying to” or “reacting to.” For example, “in response to a signal” means “replying to a signal” or “reacting to a signal” without necessity of direct signal reception.

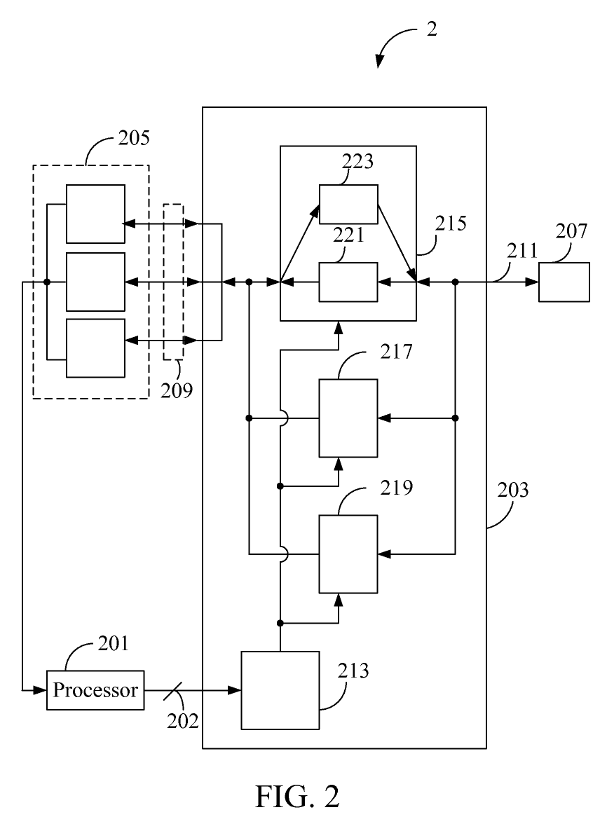

FIG. 2 shows a first embodiment of the present invention, which is a digital television system 2. The digital television system 2 comprises a processor 201, a memory controller 203, memory agents 205, and a memory 207. The processor 201 generates a control signal 202 to control access to the data packets. In response to the control signal 202, the memory controller 203 writes a data packet to or reads a data packet from the memory 207. The data packet comprises frames displayed by the digital television system 2.

The memory controller 203 comprises a register 213, a data packet adjuster 215, a burst length determination unit 217, and a frequency determination unit 219. The register 213 sets a data bus width in response to the control signal 202 and transmits information of the data bus width to the data packet adjuster 215, the burst length determination unit 217, and the frequency determination unit 219. The data packet adjuster 215 comprises a data packet collector 221 and a data packet splitter 223 for adjusting the data packet according to the data bus width. The burst length determination unit 217 determines a burst length (BL) according to the data bus width. The frequency determination unit 219 determines an operating frequency of the memory controller 203 according to the data bus width, wherein the operating frequency comes from an internal clock (INTCLK) of the digital television system 2. The memory controller 203 writes or reads the adjusted data packet in response to the burst length and the operating frequency. The memory agents 205 monitor the resources of the digital television system 2. Once the digital television system 2 is available, the memory agents 205 will pass the adjusted data packet to the processor 201 or the memory controller 203. The memory agents 205 communicate with the memory controller 203 via internal memory buses 209. The memory 207, a DDR-II DRAM or SDRAM, stores the data packet or the adjusted data packet. The memory 207 communicates with the memory controller 203 with an external memory bus 211.

More specifically, the bandwidth of the external memory bus 211 is N bits, while the bandwidth of the internal memory buses 209 is M×N bits, wherein M and N are both positive integers. When the processor 201 requests to read a data packet from the memory 207, the data packet collector 221 collects M N-bit unprocessed data packets from the memory 207 to form the adjusted data packet because the bandwidth of the external memory bus 211 is smaller than that of the internal memory buses 209. Therefore, the width of the adjusted data packet is M×N bits, which is equal to the bandwidth of the internal memory buses 209. For example, if the bandwidth of the external memory bus 211 is 4 bits and the bandwidth of the internal memory buses 209 is 8 bits, then N=4 and M=2. However, if the bandwidth of the external memory bus 211 is 2 bits, then N=2 and M=4. The operating frequency of the memory controller 203 and the memory agents 205 is proportional to the value of N. That is, if N=4, the operating frequency is, for example, 400 MHz, and if N=2, the operating frequency is 200 MHz.

The data packet collector 221 may comprise a plurality of sub-collectors (not shown) and a multiplexer (not shown). Each sub-collector collects data packets from one particular bandwidth of the external memory bus 211. For example, if the external memory bus 211 has two possible bandwidths of 4 bits and 2 bits, the data packet collector 221 comprises two sub-collectors: one for collecting data packets when the bandwidth is 4 bits, and the other for collecting data packets when the bandwidth is 2 bits. The multiplexer receives the outputs of the sub-collectors and selects one of the outputs to send to the memory agents 205 in response to the control of the processor 201.

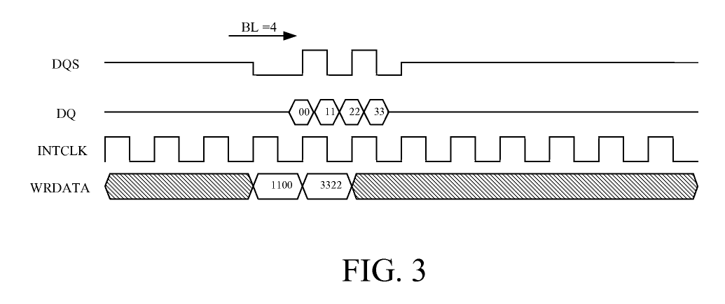

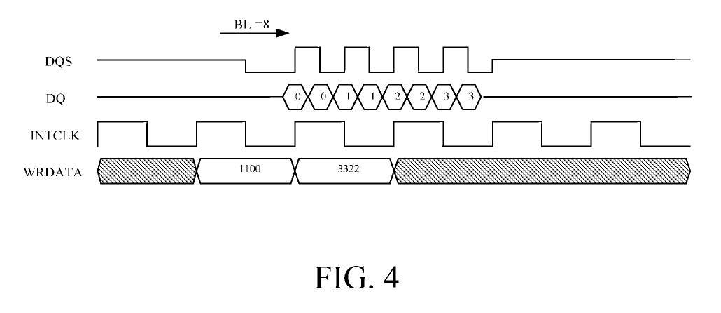

When the processor 201 requests to write an M×N-bit data packet into the memory 207, the data packet splitter 223 splits the data packet because the bandwidth of the external memory bus 211 is smaller than that of the internal memory buses 209. The data packet splitter 223 splits the M×N-bit unprocessed data packet to form M adjusted data packets, each with a width of N bits. FIG. 3 shows the timing diagram when a write operation is executed and BL=4, wherein DQS denotes a write/read data strobe, DQ denotes the adjusted data packets under N=4, INTCLK denotes the clock set by the frequency determination unit 219, and WRDATA denotes the M×N-bit data packet. As FIG. 3 shows, there are two data packets “1100” and “3322” in WRDATA. In addition, the two data packets are split into four data packets “00”, “11”, “22”, and “33” in the DQ for the external memory bus 211 to transmit. FIG. 4 shows the timing diagram when BL=8 and N=2. The two data packets are now split into eight data packets “0”, “0”, “1”, “1”, “2”, “2”, “3” and “3” in the DQ for the external memory bus 211 to transmit.

The data packet splitter 223 may comprise a plurality of sub-splitters (not shown) and a multiplexer (not shown). Each sub-splitter splits data packets from one particular bandwidth of the external memory bus 211. The multiplexer receives the outputs of the sub-splitters and selects one of the outputs to send to the memory 207 in response to the control of the processor 201.

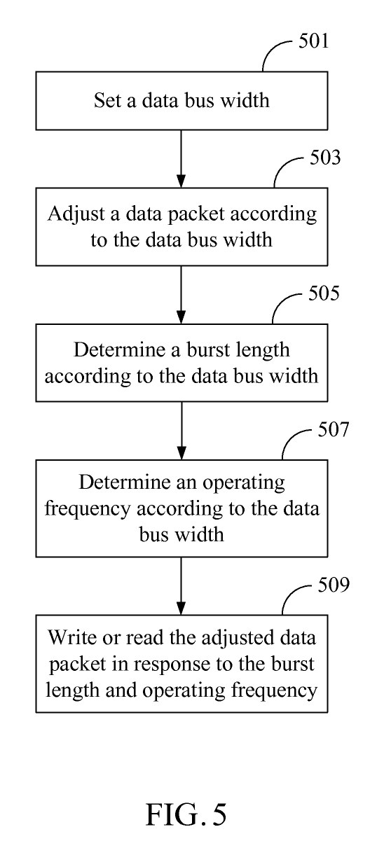

A second embodiment of the present invention is a method adapted for a memory controller, as noted in the first embodiment. FIG. 5 shows a flow chart of this method. In step 501, a data bus width is set. In step 503, a data packet is adjusted according to the data bus width. Step 505 determines a burst length according to the data bus width. Step 507 is then executed to determine an operating frequency according to the data bus width. Finally, writing or reading the adjusted data packet in response to the burst length and the operating frequency is executed in step 509.

In addition to the steps shown in FIG. 5, the second embodiment is able to execute all of the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

The bandwidth of the internal memory buses between the memory controller and the memory agents can be unified in accordance with the present invention. In other words, the memory agents do not need to deal with the memory buses with different bandwidths. Thus, the cost is reduced.

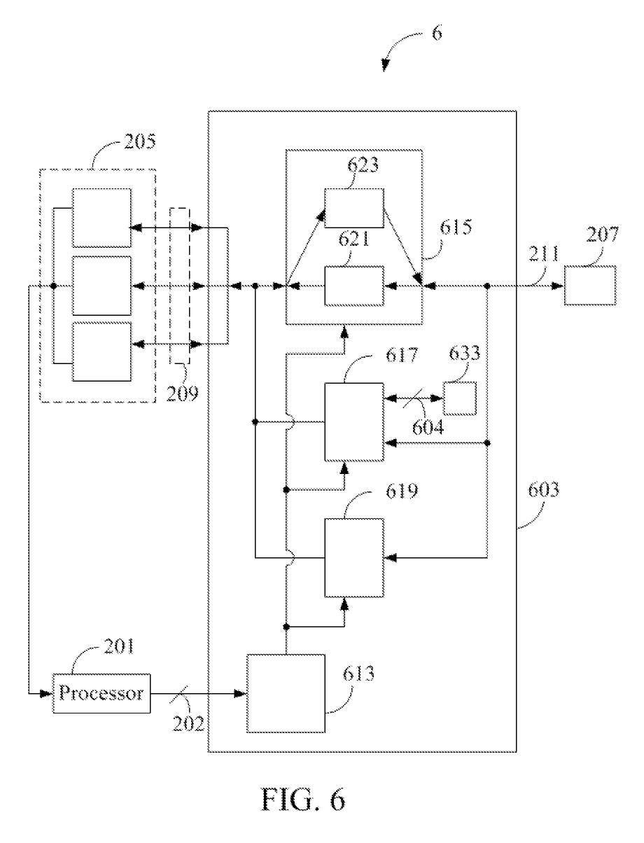

FIG. 6 shows a third embodiment of the invention, which is a digital television system 6. The digital television system 6 comprises a processor 201, a memory controller 603, memory agents 205 and a memory 207. Please note that the processor 201, the memory agents 205 and the memory 207 operate in the same way as FIG. 2, and the descriptions for those operations and functions are not repeated herein.

The memory controller 603 comprises a first register 613, a second register 633, a data packet adjuster 615, a burst length determination unit 617 and a frequency determination unit 619. The first register 613 sets a data bus width and transmits information of the data bus width to the data packet adjuster 615, the burst length determination unit 617 and the frequency determination unit 619. The burst length determination unit 617 determines a burst length according to an operating frequency 604 of the memory controller 603 which can be stored in the second register 633. It should be noted that in other embodiments, the second register 633 may not be the necessary matter in a digital television system, and instead, the operating frequency 604 can be instantly determined by the frequency determination unit 619 according to the data bus width without being stored in the second register. Besides, the operating frequency 604 can be determined by the frequency determination unit 619 according to the data bus width and then be stored in second register 633.

The data packet adjuster 615 comprises a data packet collector 621 and a data packet splitter 623 for adjusting the data packet according to the data bus width and the burst length. The memory controller 603 writes or reads the adjusted data packet in response to the burst length. Please note that the elements not detailed described herein operate similarly to those in FIG. 2, and further descriptions are omitted.

More specifically, in one case, the frequency determination unit 619 provides a plurality of candidate operating frequencies to be selected even under an environment setting, the environment setting comprising a type of the memory and width and frequency settings of a bus between the memory 207 and the memory controller 603, where the bus is configured to connect the memory 207 and the memory controller 603. The burst length determination unit 617 also obtains a value of a width of the bus and a value of a frequency of the bus to determine the burst length. The frequency determination unit 619 dynamically switches among the candidate operating frequencies of the memory controller 603 according to a power consumption requirement. For example, to save power, the frequency determination unit 619 switches the memory controller 603 from a normal operating frequency to a lower operating frequency, and the burst length determination unit 617 consequently switches the burst length from a normal burst length to a bigger burst length, and vice versa.

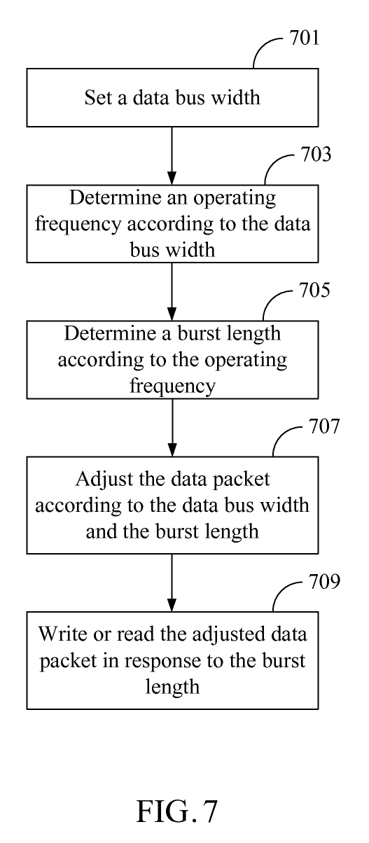

A fourth embodiment of the present invention is a method adapted for a memory controller, as noted in the third embodiment. FIG. 7 shows a flow chart of the method. In step 701, a data bus width is set. Step 703 is executed to determine an operating frequency of a memory controller according to the data bus width. Then, step 705 is executed to determine a burst length according to the operating frequency. In step 707, a data packet is adjusted according to the data bus width and the burst length. Finally, step 709 is executed to write or read the adjusted data packet in response to the burst length.

In addition to the steps shown in FIG. 7, the fourth embodiment is able to execute all of the operations or functions recited in the third embodiment. Those skilled in the art can straightforwardly realize how the fourth embodiment performs these operations and functions based on the above descriptions of the third embodiment. Therefore, the descriptions for these operations and functions are redundant and not repeated herein.

As mentioned above, the present invention provides a solution that deals with memory buses with different bandwidths and thus reduces the production cost. The advantages of the present invention further include adding more flexibility to the design of the memory controller to satisfy different requirements. For example, the memory controller may adopt a higher operating frequency and a smaller burst length to support a higher speed, and switch to a lower operating frequency and a bigger burst length to save power.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A memory controller for writing a data packet to or reading a data packet from a memory, comprising:
a first register for storing a data bus width;
a second register for storing an operating frequency of the memory controller;
a burst length determination unit for determining a burst length according to the operating frequency; and
a data packet adjuster for adjusting the data packet according to the data bus width and the burst length;
wherein the memory controller writes or reads the adjusted data packet in response to the burst length.

2. The memory controller of claim 1, further comprising a frequency determination unit for determining the operating frequency of the memory controller.

3. The memory controller of claim 2, wherein the frequency determination unit provides a plurality of candidate operating frequencies to be selected under an environment setting comprising a type of the memory.

4. The memory controller of claim 3, wherein the environment setting further comprises width and frequency settings of a bus, and the bus is configured to connect the memory and the memory controller.

5. The memory controller of claim 2, wherein the frequency determination unit is further configured to dynamically switch the memory controller from a normal operating frequency to a lower operating frequency for saving power, and the burst length determination unit is further configured to switch the burst length from a normal burst length to a bigger burst length.

6. The memory controller of claim 2, wherein the frequency determination unit determines the operating frequency according to a power consumption requirement.

7. The memory controller of claim 2, wherein the frequency determination unit determines the operating frequency according to the data bus width.

8. The memory controller of claim 1, wherein the burst length determination unit further obtains a value of a width of a bus, and the bus is configured to connect the memory and the memory controller.

9. The memory controller of claim 1, wherein the burst length determination unit further obtains a value of a frequency of a bus, and the bus is configured to connect the memory and the memory controller.

10. The memory controller of claim 1, wherein the data packet adjuster is a collector for collecting the data packet.

11. The memory controller of claim 10, wherein the collector collects a plurality of M×N-bit unprocessed data packets to form the adjusted data packet, and a width of the adjusted data packet is M×N bits.

12. The memory controller of claim 1, wherein the data packet adjuster is a splitter for splitting the data packet.

13. The memory controller of claim 12, wherein the splitter splits an M×N-bit unprocessed data packet to form the adjusted data packet, and a width of the adjusted data packet is N bits.

14. A method for writing a data packet to or reading a data packet from a memory, comprising the following steps of:
setting a data bus width;
determining an operating frequency of a memory controller;
determining a burst length according to the operating frequency; and
adjusting the data packet according to the data bus width and the burst length;
wherein the adjusted data packet is written or read in response to the burst length.

15. The method of claim 14, further comprising a step of:
determining the operating frequency according to the data bus width.

16. The method of claim 14, wherein the step of determining the operating frequency further comprises a step of:
providing a plurality of candidate operating frequencies to be selected under an environment setting;
wherein the environment setting comprises a type of the memory.

17. The method of claim 16, wherein the environment setting further comprises width and frequency settings of a bus, and the bus is configured to connect the memory and the memory controller.

18. The method of claim 14, wherein the step of determining the operating frequency step further comprises the steps of:
switching the memory controller from a normal operating frequency to a lower operating frequency dynamically for saving power; and
switching the burst length from a normal burst length to a bigger burst length.

19. The method of claim 14, wherein the step of determining the burst length further comprises a step of:
obtaining a value of a width of a bus;
wherein the bus is configured to connect the memory and the memory controller.

20. The method of claim 14, wherein the step of determining the burst length further comprises a step of:
obtaining a value of a frequency of a bus;
wherein the bus is configured to connect the memory and the memory controller.

21. The method of claim 14, wherein the step of determining the operating frequency further comprises a step of:
determining the operating frequency according to a power consumption requirement.

22. The method of claim 14, wherein the adjusting step further comprises a step of: collecting the data packet.

23. The method of claim 22, wherein the collecting step further comprises a step of:
collecting a plurality of M×N-bit unprocessed data packets to form the adjusted data packet;
wherein a width of the adjusted data packet is M×N bits.

24. The method of claim 14, wherein the adjusting step further comprises a step of:
splitting the data packet.

25. The method of claim 24, wherein the slitting step further comprises a step of:
slitting an M×N-bit unprocessed data packet to form the adjusted data packet;
wherein a width of the adjusted data packet is N bits.
